(19) United States
(12) Patent Application Publication
(10) Pub. No.: US 2008/0170700 A1
(43) Pub. Date: Jul. 17, 2008

(54) SYSTEM FOR CONTROLLING ACCESS TO DIGITAL INFORMATION

(76) Inventor: Prashanth Darba, Madison, WI (US)

Correspondence Address: Intellectual Property Department;DEWITT ROSS & STEVENS S.C., 2 East Mifflin Street, Suite 600, Madison, WI, 53703-2865, US

(21) Appl. No.: 12/015,921

(22) Filed: Jan. 17, 2008

Related U.S. Application Data
(60) Provisional application No. 60/885,316, filed on Jan. 17, 2007.

(51) Int. Cl. H04L 9/08; H04L 9/28

(52) U.S. Cl. 380/278; 380/28

(57) ABSTRACT

Described is a method for renting or selling digital content, and a corresponding system for carrying out the method. The method includes the steps of providing a digital content storage device having stored therein digital content to be rented; embedding within the digital content storage device a firmware lock that disables access to the digital content in the absence of a corresponding digital key; providing a digital content player dimensioned and configured to access and play the digital content stored in the digital content storage device, and configuring the digital content player such that it is incapable of accessing or playing the digital content in the absence of the corresponding digital key. The corresponding digital key is then provided to a user desirous of renting or buying the digital content stored on the digital content storage device, wherein the digital content player is configured to access and to play the digital content when, and only when, the corresponding digital key is transmitted to the firmware lock. The digital key is then transmitted to the firmware lock, thereby allowing access to the digital content.

### CROSS-REFERENCE TO RELATED APPLICATIONS

Priority is hereby claimed to provisional application Ser. No. 60/885,316, filed Jan. 17, 2007, which is incorporated herein.

### BACKGROUND

Digital Rights Management (DRM) is a general term that refers to protocols and technologies used by publishers and copyright owners to control access to and duplication of proprietary digital information. DRM is something of a controversial topic among producers of digital content versus consumers of that digital content. Not surprisingly, producers of digital content (e.g., film and music producers, software developers, etc.) take the position that DRM is necessary for copyright holders to prevent unauthorized duplication of their work. It is beyond rational debate that pirated movies, software, and recorded music has vastly cut into the legitimate financial returns of these content producers. Digital piracy and illegal redistribution of copyrighted material is a rampant, worldwide problem. Some estimates put the losses to due to digital piracy at approximately $30 billion per year. A lack of mobile DRM in Europe alone to costs an estimated 3.5B Euros per year. Approximately 36% of all software run on U.S. computers is pirated.

Advocates of free software, in contrast, argue that copyright holders are attempting, through the auspices of DRM, to restrict legitimate uses of copyrighted material in ways not authorized by statutory or common law protections afforded by the copyright laws. This position is difficult to reconcile with the practical reality that the vast majority of unauthorized duplicated digital content is made for illegal redistribution (either informally for distribution to friends and family, or by for-profit bootlegging operations).

Thus, while the concept of DRM may involve some amount of legal and societal controversy, there is no arguing that unauthorized duplication of copyrighted digital information is a vast and growing problem. Because it can be copied ad infinitum, without degradation, digital information is a ripe target for those who would profit illegal from the creative effort of others. Copying technology of every description has met opposition from copyright holders, music distributors, and broadcasting companies since the dawn of the technological age. From player piano rolls, to vinyl records, to reel-to-reel tapes, to cassette tapes, to video tapes, and now to recordable CD and DVD disks, thumb drives, memory sticks, and the like, each generation of content producers has been faced with new predations based on evolving technology. The problem is intensified not only due to the ease of duplicating digital information, but also to the near-magical miniaturization of digital information storage devices. Devices capable of storing titanic amounts of digital information, tens of gigabytes to terabytes, are now commonplace. MP3 players the size of a cigarette lighter and capable of storing 30 GB or more are now commonplace.

Add to this technological evolution in recording the parallel evolution of the Internet, and it is clear to see why content producers are very keen to develop realistic DRM protocols. The advent of the Internet, coupled with broad-band access to the Internet, enables vast amounts of digital information to be transferred to literally any corner of the globe, in seconds, and largely anonymously.

A number of DRM schemes have been introduced to the market, and virtually all of them have met with limited success or outright failure. For example, DIVX (Digital Video Express) was a DRM rental format variation on the DVD player. Customers would buy a DIVX disc (similar to a DVD) at a low cost, which would be able to be freely viewed up to 48 hours from its initial viewing. After this period, the disc could be viewed by paying a continuation fee. DIVX discs could only be played on special DIVX/DVD combo players that needed to be connected to a phone line. The DIVX system required a phone line, which greatly limited using the rented disks without tying up the phone. The format was a commercial failure. Introduced to the market in late 1998, it was discontinued in June of 1999.

Content-scrambling systems (CSS) restrict the owners' use of purchased content. CSS generally also prevents the user from playing as CSS-encrypted DVD on any computer platform. These types of encryption formats are roundly derided by the buying public because having purchased the content, the buyer should be able to use it in any legally-permissible fashion. (CSS formats prevent making personal copies or compilations, actions that are generally permissible under the fair use doctrine of US law.)

The Digital Millennium Copyright Act (DMCA) is a United States copyright law passed unanimously on May 14, 1998, that makes it a crime to produce and disseminate technology that allows users to circumvent copyright protection methods. In short, the DMCA renders illegal in the United States all forms of DRM-stripping and DRM-circumvention software. A similar set of laws, the EU Copyright Directive, was implemented in the European Union in 2001. The EU Copyright Directive criminalizes many in Europe many of the same actions made criminal in the U.S. by the DMCA. While these laws were well-intentioned, they have done precious little to stem the tide of digital piracy in both the US and around the globe.

There remains, therefore, a long-felt and unmet need for a DRM solution that addresses both the anti-piracy concerns of the content producers, and the ease-of-use and anonymity concerns of content consumers. The present invention addresses these needs.

### SUMMARY OF THE INVENTION

The invention is directed to a method for renting or selling digital content. The method comprises providing a digital content storage device having stored therein digital content to be rented. Within the digital content storage device is embedded a firmware lock that disables access to the digital content in the absence of a corresponding digital key. A digital content player dimensioned and configured to access and to play the digital content stored in the digital content storage device is provided. The digital content player is configured such that it is incapable of accessing or playing the digital content in the absence of the corresponding digital key.

The corresponding digital key is provided to a user desirous of renting or buying the digital content stored on the digital content storage device. The digital content player is configured to access and to play the digital content when, and only when, the corresponding digital key is transmitted to the firmware lock. Thus, the digital content cannot be accessed on an unauthorized basis. Only the key holder can access the digital content, which is accomplished by transmitting the digital key to the firmware lock.

The digital content storage device can be any device dimensioned and configured to store and selectively access digitized information without limitation, now known or developed in the future. Preferably, the digital content storage device is selected from the group consisting of a server, a magnetic disc, a magnetic tape, an audio compact disc, a video compact disc, a memory chip, portable flash memory drives (or sticks) and portable biometric memory drives.

The firmware lock and key can comprise any suitably robust encryption means to prevent unauthorized access to the digital content, including biometric lock and key devices (fingerprint scanner, iris scanners, etc.). The lock and key may also be mathematical encryption algorithms, such as Advanced Encryption Standard (AES)—compliant code, or other types of Rijndael ciphers, preferably of at least 128 bits, more preferably 196 bits, and more preferably still 256 bits.

Like the digital content storage device, the digital content player may be any player now known or developed in the future for selectively accessing and playing digital content (audio, video, data, documents, games, etc.). Preferably, the digital content player is selected from the group consisting of a computer, a digital audio tape player, a compact disc player, a video compact disc player, a memory drive player, smart phones and PDA with embedded media players, and any personal media players (“PMP”). The digital key may optionally be integrated directly into the digital player, or the digital key may be carried on a separate device or transmitted to the player from a separate device, e.g., the digital key may be transmitted to the firmware lock via a local area network, a wide-area network, or a global computer network.

In one version of the invention, the digital content storage device is a remote server accessible by a global computer network, and the digital content player is a remote computer operationally connected to the remote server via the global computer network. In this version of the invention, the digital key is transmitted from the remote computer to the remote server via the global computer network.

The corresponding system for renting or selling digital content comprises, in combination: a digital content storage device having stored therein digital content to be rented; a firmware lock embedded within the digital content storage device that disables access to the digital content in the absence of a corresponding digital key; a digital content player dimensioned and configured to access and to play the digital content stored in the digital content storage device, wherein the digital content player is configured such that it is incapable of accessing or playing the digital content in the absence of the corresponding digital key; and the corresponding digital key, wherein the digital content player is configured to access and to play the digital content when, and only when, the corresponding digital key is transmitted to the firmware lock.

### BRIEF DESCRIPTION OF THE DRAWINGS

FIG. 1 is a schematic representation of an embodiment of the present invention.

FIG. 2A is a schematic representation of the “SubBytes” sub-routine in the Advanced Encryption Standard (AES) protocol. In the SubBytes step, each byte in the state is replaced with its entry in a fixed 8-bit lookup table, S; bᵢⱼ=S(aᵢⱼ).

FIG. 2B is a schematic representation of the “ShiftRows” sub-routine in the AES protocol. In the ShiftRows step, bytes in each row of the state are shifted cyclically (to the left or right; to the left is shown in the figure). The number of places each byte is shifted differs for each row.

FIG. 2C is a schematic representation of the “MixColumns” sub-routine in the AES protocol. In the MixColumns step, each column of the state is multiplied with a fixed polynomial c(x).

FIG. 2D is a schematic representation of the “AddRoundKey” step in the AES sub-routine. In the AddRoundKey step, each byte of the state is combined with a byte of the round subkey using and “exclusive/or” (XOR) operation. The XOR operation is a logical disjunction on two operands that results in a value of “true” if and only if exactly one of the operands has a value of “true.”

### DETAILED DESCRIPTION OF THE INVENTION

The invention, referred to herein as Digital Media Armor (DMA), is a new paradigm for the video- and game-rental industries that utilizes a highly portable, anonymous, lock-and-key combination of firmware (i.e. software embedded in hardware) and access to a database of desirable content, to allow anonymous rentals of digital content (movies, video games, music, etc.) that are either time-limited (e.g., 48 hours and then the digital content is no longer accessible) or number-of-views limited (hereinafter “view-limited,” e.g., 10 plays and then the digital content is no longer accessible). The method does not require access to the Internet or a telephone (although, as described herein, the Internet can be used to access the database that contains the content that is for rent and for updating the attributes of the key).

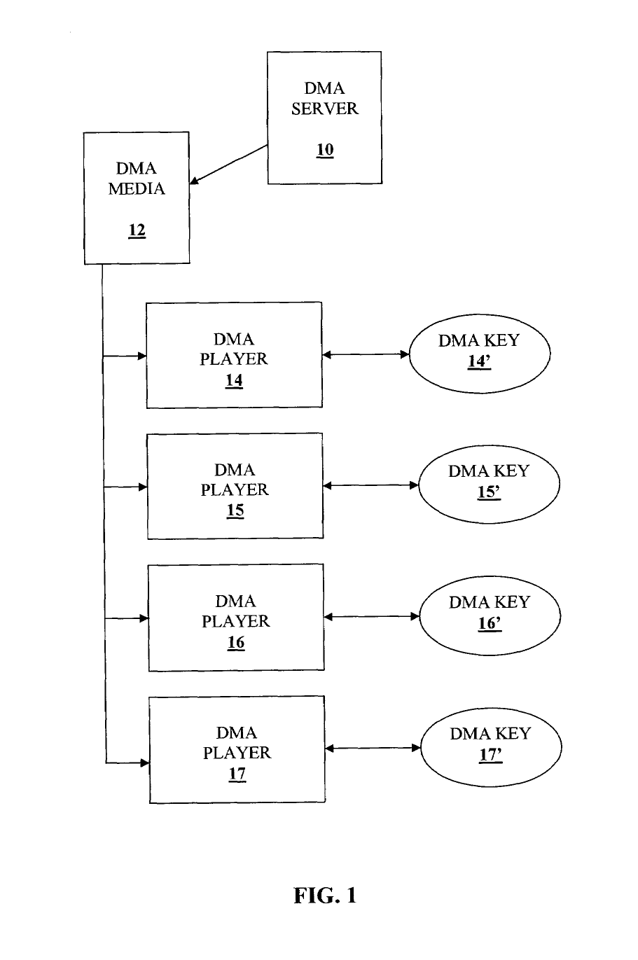

Referring now to FIG. 1, the invention comprises a method wherein the user is provided a player, such as a combination DVD/CD player, computer, PMP, set-top box, and the like, and a proprietary digital content storage device that provides the digital content to be played by the player. In FIG. 1, a series of distinct players, designated DMA PLAYER 14, 15, 16, and 17 are shown. As used herein, the term “digital content storage device” refers to any device, passive or active, that is capable of storing, retrieving and providing to the player a suitable digital information stream to reproduce the desired content (e.g. a movie, song, or video game). In FIG. 1, the digital content storage device is shown as DMA MEDIA 12. Of critical importance to the success of the method is a firmware “key” that is provided either separately to the consumer or which is embedded within the digital content storage device. As shown in FIG. 1, a series of separate DMA KEYS 14′, 15′, 16′, and 17′ are shown. The key is complementary to a firmware lock that is associated with the digital content placed on the storage device. The DMA MEDIA 12 can be inserted into any of the DMA PLAYERS 14, 15, 16, or 17. But the DMA MEDIA will only function in the DMA PLAYER that also has inserted into it (or in communication with it) a corresponding DMA KEY (i.e., 14′, 15′, 16′, or 17′, respectively). In short, the key dictates both who has access to the digital content, for how long, and/or how many times the firmware lock can be opened using that particular key. The method explicitly includes a firmware “lock” that can be opened by more than one key, so that (if desired) multiple users can access the digital content stored on any given storage device.

The invention provides a number of very desirable traits from the perspective of both the consumer and the content provider. From the eyes of the consumer, the invention provides “burn & Go” capabilities by storing the encoded digital content directly onto the consumer's VCD/DVD, memory stick, or other portable digital content storage device (i.e., any form of DMA MEDIA 12). This can be done over the Internet, thus eliminated the customer's need to go to the rental store in the first place. Likewise, the customer is relieved of the duty to return to the store to drop off a rented DVD. The digital content, once timed-out or viewed-out, is rendered inaccessible to the user.

The source of the digital content is a DMA SERVER 10 maintained by the content provider, which server is loaded with digital content obtained directly from the content maker or an authorized middle man. Thus, from the provider's perspective, business concerns such as low inventory or out-of-stock inventory are not applicable. The entire inventory of digital content for rental is always housed in the provider's server.

The system is extremely flexible. Customers may rent content in the same fashion as the conventional movie rental business directly from a bricks and mortar store or a DVD vending machine (now known as DVD kiosks that are housed in retail stores) or developed in future to include memory stick vending machine, but without the need to return the digital media. Or the customer can order on-line with mail delivery, in the same fashion as NetFlix, but without the need to return the digital media. Or the digital content can be ordered on-line and downloaded via broadband internet access, cable modem, satellite, DSL, or any other analogous global computer network, now known or developed in the future. Thus, as shown in FIG. 1, the arrow extending from the DMA SERVER 10 to the DMA MEDIA 12 is an operational connection that can be made in person, over the phone, over the Internet, via the mail, etc. In short, the digital content to be disposed onto the DMA MEDIA 12 may be transmitted to the holder of the DMA MEDIA by any means.

For the provider, the system does away with return shipments, thus reducing operating costs. The buyer has no more waiting for available titles, thus increasing the provider's sales through both constantly available inventory and customer satisfaction

Note also that the system can be implemented in either a rental format (in which case the DMA Key “times out” after a certain number of plays or a certain amount of time) or in an outright sale format. In the case of implementing the method as an outright sale of the media, the DMA Key never times out. The original purchaser can access the purchased DMA-protected media for so long as he has the corresponding DMA Key. The purchaser can even sell the DMA-protected media by selling along with the DMA Media the corresponding DMA Key (so that the new purchaser can access the content).

For the content producer, the system protects their very valuable copyrighted intellectual property by providing limited access only to those individuals who are authorized (and have paid) to have access to the content.

The system uses a number of interlocking pieces of hardware, software, and firmware to provide only authorized access to digital media. The first element of hardware is referred to herein as the DMA-Box. The DMA-Box comprises a digital media player, such as a DVD player, PMP, digital computer, video game console, set-top box, and the like, that includes a key card slot and ports for plugging in one or more of a removable memory stick, flash drive, thumb drive, DVD, CD, etc. Again, in FIG. 1, this element of the invention is designated DMA PLAYER The player is dimensioned and configured to play regular, unencrypted digital media, as well as digital media encrypted according to the present invention. Digital content encrypted according to the present invention are decrypted on the fly and playable through the player only when a valid DMA KEY (described below) is used. Streaming video of a decrypted movie is buffered to a video screen input devices. The DMA KEY includes software-encoded instructions that time lock the digital content, either for an absolute amount of time (e.g., 24 hours, 48 hours, 7 days, etc.) or locked for the number of times the digital content can be accessed. For disposable DMA MEDIA, such as a CD or DVD, the DMA-protected data is burnt to conventional DVDs, which the user is then free to discard once the DMA-KEY “times out” and restricts access to the DVD. Alternatively, the digital content can be downloaded to the user's memory stick, flash drive, or other digital content storage device. Note that regardless of the DMA MEDIA onto which the digital content is stored, it is always encrypted and inaccessible without the matching DMA KEY. For added protection, the digital content can be downloaded to biometric-enabled storage drives—that is, storage devices that require biometric data of the owner (such as a fingerprint), as well as the DMA KEY, in order to gain access to the digital contents stored on the device.

Note also that the DMA PLAYER and the DMA MEDIA may be an integrated unit, such as a personal computer. In this version of the invention, the server and the user's computer are connected by any means now known in the art or developed in the future. The user can then use his personal computer to download DMA-encoded content from the server to a drive on the user's personal computer. In this version of the invention the DMA MEDIA 12 is a drive on the user's personal computer, and the computer itself is the DMA PLAYER. The DMA KEY may be downloaded from the server along with the digital content to be accessed, or the DMA KEY may be provided as a separate piece of hardware, firmware, or software that is loaded onto the user's computer (and thus enables the user to access the downloaded content).

The content to be rented to the users is stored in a centralized DMA-SERVER 10. The server has libraries of movies and games that are DMA-protected and used for burning onto the users' disposable or portable media as described in the previous paragraph.

The servers do not need to be manned by a human in order to be accessible to the public. For example, the server can be made available in kiosks in malls, airports, train stations, bus terminals, hotel lobbies, and the like.

The lynch pin of the entire system is the DMA KEY. Each customer receives a free DMA PLAYER and a unique DMA KEY that works with the specific DMA PLAYER or a plurality of specifically designated DMA PLAYERS. That is, a user may have a slew of DMA PLAYERS: an PMP/CD/DVD player in his car, his living room, his bedroom and in his summer cottage. A single DMA KEY can be programmed to allow DMA-encrypted media to be played in all of these devices. Depending upon the providers' need, the DMA KEYS can be utterly anonymous. That is, the key is sold to buyers without gathering any identifiable information from the buyer. The buyer must pay for the key in any event, so the provider is paid, regardless of whether the buyer's biographical information is divulged. Alternatively, the DMA-KEY may be an interactive storage device onto which is keyed the buyer's personal information, credit card information, and the like. In this fashion, the key acts as a logging device for purposes of billing and user-tracking. In this version, the DMA KEY keep a running log of what movies were played, when, on what device, etc. When the user returns to the server to have additional content downloaded to his DMA removable drive, the information stored on the key is downloaded to the DMA Server.

The user must also have one or more DMA Removable Drives. The DMA Removable Drive is any digital storage device, e.g. memory sticks, flash drives, computer hard drives, and the like, onto which are stored the DMA-protected movies/games. In the preferred version of the invention, the DMA Removable Drive is dimensioned and configured to hold a relatively large amount of digital information. Instead of renting one movie on a single DVD, a complete set of movies can be rented, downloaded to a DMA Removable Drive, and enjoyed at the user's convenience. If the downloaded media is view-limited (rather than time-limited), the user could literally download a year or more worth of movies at one sitting, and not access the system again until all of the movies have been viewed. This is particularly useful for vacation or long trips, where a host of movies may be viewed in a relatively short period of time.

Lastly, the system includes disposable DMA MEDIA 12, such as DVDs, VCDs, memory drives, and the like, that are discarded after they expire.

Thus, the system is vastly flexible because regardless of how the content is provided, and regardless of the media onto which the content is encoded, the content cannot be accessed without the DMA KEY. The DMA KEY can also be recharged remotely to extend the period of rentals. Thus, for example, the server may be located in an otherwise conventional walk-up or drive-through retail location. Users would simply provide their key and DMA MEDIA, select the movies they'd like downloaded to the drive, and both the DMA MEDIA and the DMA KEY are updated. Likewise, the entire process can be duplicated on-line, with the DMA KEY being plugged into a port on the user's computer so that the key can be updated when the new DMA-encoded content is loaded onto the removable drive.

Similarly, there's no need for the user even to bring his DMA MEDIA into the store (if the system is implemented as a drive-up or walk-up store). The user can simply drop off his old DMA MEDIA (i.e., his “timed-out” memory stick or flash drive) and pick up a replacement DMA MEDIA that has already been charged with a new library of rental movies. (The user can even call or order on-line in advance so that the new DMA MEDIA is charged and ready to go when the user arrives at the store.)

Regarding the encryption used to generated the DMA KEY, any suitable encryption method may be utilized, including biometric encryption such as fingerprint readers (commercially available from a host of worldwide suppliers, including DigitalPersona, Inc., Redwood City, Calif.), retinal and/or iris scanners (commercially available from, for example, Panasonic Corporation North America, Secaucus, N.J.), and the like. When the DMA KEY is a firmware key or other mathematical-based encryption, 128-bit encryption is preferred as a minimum level of encryption strength. A preferred encryption method is any Rijndael cipher-based approach (128-bit, 196-bit, 256-bit) now known or developed in the future. Preferred for use in the present invention is encryption using the Advanced Encryption Standard, a 128-bit Rijndael cipher, or a 256-bit Rijndael cipher.

The Advanced Encryption Standard (AES), a Rijndael-based cipher, is a block cipher used as an encryption standard. AES has been formally adopted by the U.S. government and many other organizations. It has been analyzed extensively and is used worldwide. (See, for example, Xiao et al. (11/2006) “NIS05-1: Performance Analysis of Advanced Encryption Standard (AES),” Global Telecommunications Conference, 2006, ISBN: 1-4244-0356-1.” A predecessor protocol, the Data Encryption Standard (DES), may also be used in the present invention (along with any other suitable encryption system). AES is very robust. The only successful attacks upon AES have been “side channel attacks,” that is, attacks based on information gained from the physical implementation of encryption, rather than on any theoretical weakness in the four-step AES encryption algorithm.

The discussion that follows will be limited to the AES standard only. This is for brevity only. Any suitable encryption protocol, now known or developed in the future may be used in the present invention. The AES was promulgated by the U.S. National Institute of Standards and Technology (NIST) as U.S. Federal Information Processing Standard Publication 197 (US FIPS PUB 197) on Nov. 26, 2001, after a five-year standardization process. US FIPS PUB 197 is incorporated herein by reference. The standard formally became effective on May 26, 2002. As of 2008, AES remains one of the most popular algorithms used in symmetric key cryptography. It is available by choice in many different encryption packages. The protocol was developed by two Belgian cryptographers, Joan Daemen and Vincent Rijmen, and was submitted to the AES selection process under the name “Rijndael.” As used herein, the term AES is used synonymously with “Rijndael,” and explicitly denotes the encryption protocol embodied in the formal AES as described herein, but implemented using any suitable block and key size, without limitation. (Strictly speaking, the formal “AES” promulgated by NIST specifies a fixed 128-bit block size; and uses keys of 128 bits, 196 bits, or 256 bits. The term “Rijndael” is used in a broader sense among cyptographers to designate the same or related protocols, but implemented using key and block sizes in any multiple of 32 bits, generally with a minimum of 128 bits and a maximum of 256 bits.)

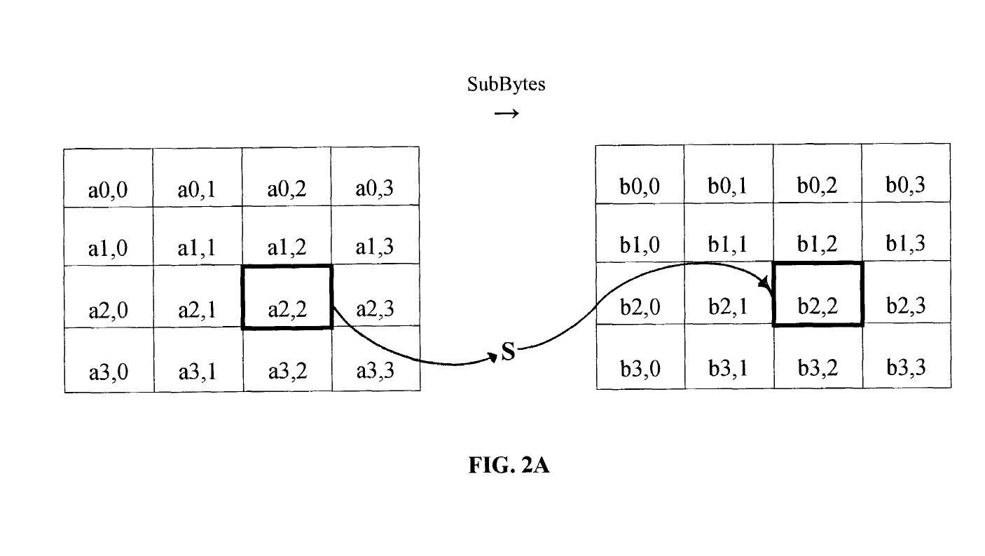

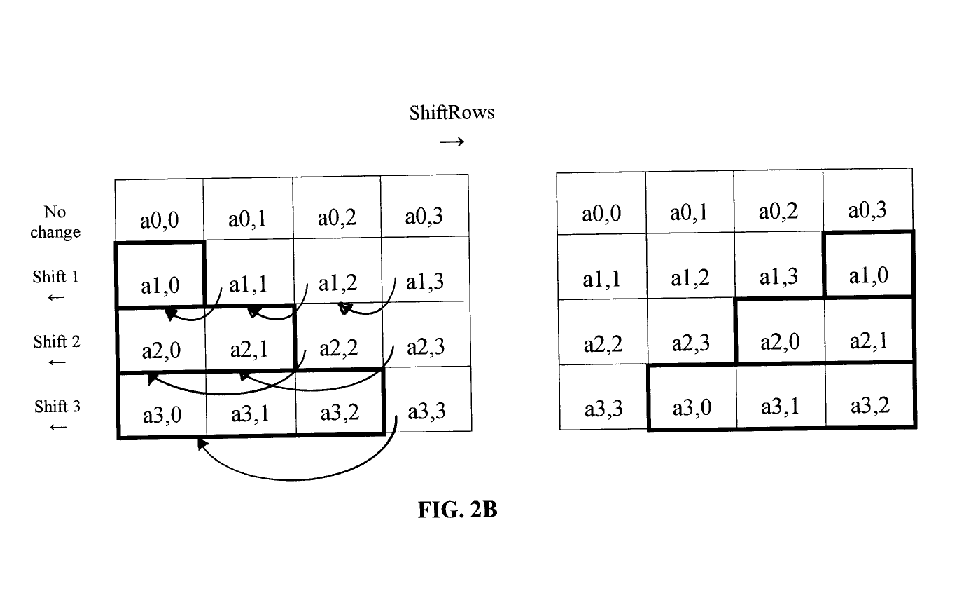

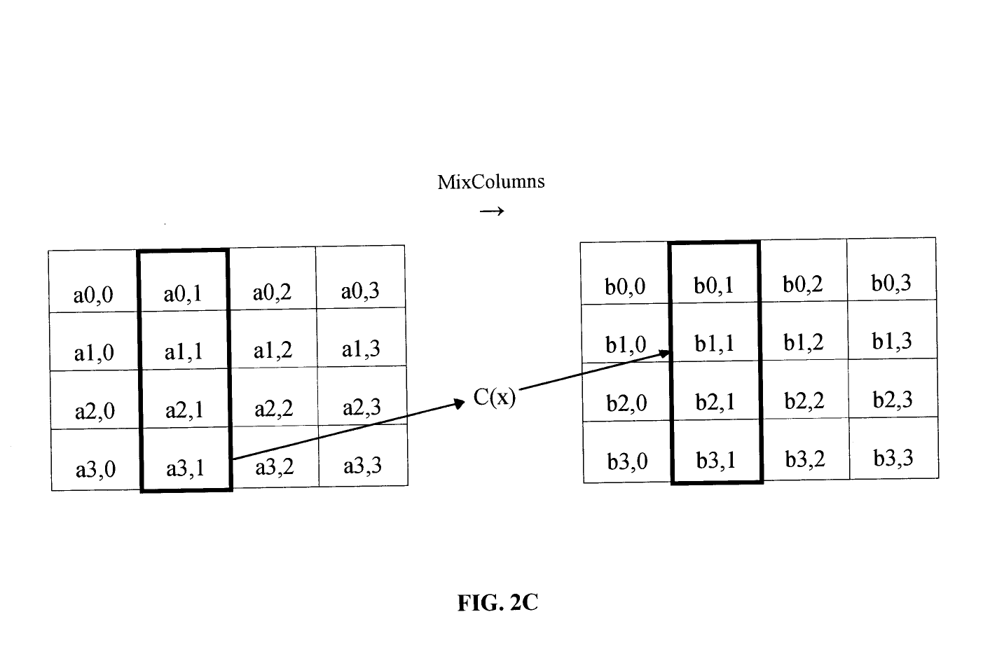

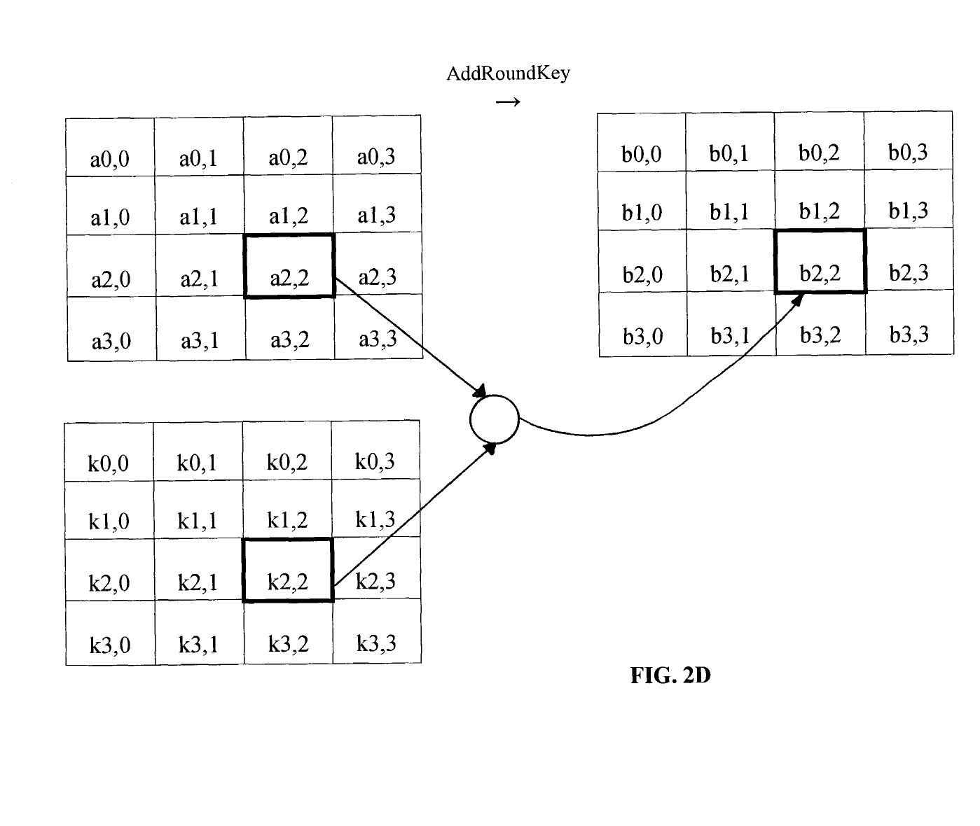

The AES operates via a series of four steps or sub-routines, each of which will be discussed in turn, with reference being made to FIGS. 2A, 2B, 2C, and 2D. The four steps are performed iteratively, in “rounds.” Each round comprises passing the initial state sequentially through each of the four steps to generate a transformed state. The transformed state is then used as the input for the next round. Each 4×4 grid in FIGS. 2A-2D utilizing an “a” bit is referred to as a “state,” i.e., the message to be encrypted and decrypted, as well as interim transformed states of the encrypted message. The 4×4 grid utilizing a “b” bit in FIG. 2A is the cipher key for encrypting and decrypting the state. The Rijndael S-box is designated simply as “S” in FIG. 2 and can be 8-bit, 16-bit, or larger.

In the SubBytes step (FIG. 2A), each byte in the state is replaced with its entry in a fixed 8-bit (or larger) lookup table or substitution box known as the Rijndael S-box: S; bᵢⱼ=S(aᵢⱼ). This operation provides the non-linearity in the cipher. The S-box used is derived from the multiplicative inverse over GF(2⁸) (for an 8-bit lookup table). This multiplicative inverse function is known to have good non-linearity properties. To avoid unauthorized decryption based on simple algebraic properties, the S-box is constructed by combining the inverse function with an invertible affine transformation. The S-box is also chosen to avoid fixed points and opposite fixed points.

In the ShiftRows step (FIG. 2B), bytes in each row of the state are shifted cyclically to the left. The number of places each byte is shifted differs for each row. In short, the ShiftRows sub-routine operates on the rows of the state by cyclically shifting the bytes in each row by a certain offset. In the AES, the first row is left unchanged. Each byte of the second row is shifted one to the left. Similarly, the third and fourth rows are shifted by offsets of two and three, respectively. For the block of size 128 bits and 192 bits the shifting pattern is the same. In this fashion, each column of the output state of the ShiftRows step is comprised of bytes from each column of the input state. Larger block sizes have slightly different offsets. In the case of the 256-bit block, which is preferred in the present invention, the first row is unchanged and the shifting for second, third, and fourth rows is 1 byte, 3 bytes and 4 bytes, respectively.

In the MixColumns step (FIG. 2C), each column of the state is multiplied with a fixed polynomial, c(x). Here, the four bytes of each column of the state are combined using an invertible linear transformation. The MixColumns function uses four bytes as an input and generates four bytes as an output. Each input byte, however, affects all four output bytes. In combination with the ShiftRows step, the MixColumns sub-routine provides diffusion in the cipher. Each column is treated as a polynomial over the GF(2⁸) finite space, and is then multiplied modulo x⁴+1 with a fixed polynomial c(x)=3x³+x²+x+2. The MixColumns step can also be viewed as a multiplication by a particular MDS matrix in Rijndael's finite field.

In the AddRoundKey step (FIG. 2D), each byte of the state is combined with a byte of the round sub-key using the exclusive-or (XOR) operation (depicted as a circle in FIG. 2D). Here, a sub-key (the lower-left array in FIG. 2D) is combined with the state. For each round, a sub-key is derived from the main key using Rijndael's key schedule; each sub-key is the same size as the state. The sub-key is added by combining each byte of the state with the corresponding byte of the sub-key using bit-wise XOR.

On systems with 32-bit or larger words, it is possible to speed up execution of the AES by combining SubBytes and ShiftRows with MixColumns, and transforming them into a sequence of table lookups. This requires four 256-entry 32-bit tables, which utilizes a total of four kilobytes (4096 bytes) of memory—one kilobyte for each table. In this approach, a single round of encryption is accomplished with sixteen table lookups and twelve 32-bit exclusive-or operations, followed by four 32-bit exclusive-or operations in the AddRoundKey step.

The AES/Rijndael cipher can be implemented with a variable number of rounds. Not counting an extra round performed at the end of encryption wherein the MixColumns step is omitted, the number of rounds in AES is 9 if both the block and the key are 128 bits long, 11 if either the block or the key is 192 bits long, and neither of them is longer than 192, and 13 if either the block or the key is 256 bits long.

Decryption is accomplished by reversing the process using the key and the Rijndael S-box used in the SubBytes sub-routine.

What is claimed is:

1. A method for renting or selling digital content, the method comprising:
(a) providing a digital content storage device having stored therein digital content to be rented;
(b) embedding within the digital content storage device a firmware lock that disables access to the digital content in the absence of a corresponding digital key;
(c) providing a digital content player dimensioned and configured to access and to play the digital content stored in the digital content storage device, and configuring the digital content player such that it is incapable of accessing or playing the digital content in the absence of the corresponding digital key; and
(d) providing the corresponding digital key to a user desirous of renting or buying the digital content stored on the digital content storage device, wherein the digital content player is configured to access and to play the digital content when, and only when, the corresponding digital key is transmitted to the firmware lock; and
(e) transmitting the digital key to the firmware lock, whereby the digital content is accessed.

2. The method of claim 1, wherein in step (a), the digital content storage device is selected from the group consisting of a server, a magnetic disc, a magnetic tape, an audio compact disc, a video compact disc, a memory chip, and an MP3 player.

3. The method of claim 1, wherein in step (b), the firmware lock and key comprise Advanced Encryption Standard (AES)-compliant code.

4. The method of claim 1, wherein in step (b), the firmware lock and key comprise a Rijndael cipher of 128 bits, 196 bits, or 256 bits.

5. The method of claim 1, wherein the digital content player is selected from the group consisting of a computer, a digital audio tape player, a compact disc player, a video compact disc player, and a personal media player.

6. The method of claim 1, wherein the digital key is integrated into the digital player.

7. The method of claim 1, wherein the digital key is not integrated into the digital player and in step (e), the digital key is transmitted to the firmware lock via a local area network, a wide-area network, or a global computer network.

8. The method of claim 1, wherein in step (a) the digital content storage device is a remote server accessible by a global computer network; in step (c), the digital content player is a remote computer operationally connected to the remote server via the global computer network, and wherein the digital key is transmitted from the remote computer to the remote server via the global computer network.

9. The method of claim 1, wherein the firmware lock and key are corresponding digitized biometric scans.

10. A method for renting or selling digital content, the method comprising:
(a) providing a digital content storage device having stored therein digital content to be rented;
(b) embedding within the digital content storage device a firmware lock that disables access to the digital content in the absence of a corresponding digital key, and wherein the digital lock and key comprise a Rijndael cipher of 128 bits, 196 bits, or 256 bits;
(c) providing a digital content player dimensioned and configured to access and to play the digital content stored in the digital content storage device, and configuring the digital content player such that it is incapable of accessing or playing the digital content in the absence of the corresponding digital key; and
(d) providing the corresponding digital key to a user desirous of renting or buying the digital content stored on the digital content storage device, wherein the digital content player is configured to access and to play the digital content when, and only when, the corresponding digital key is transmitted to the firmware lock; and
(e) transmitting the digital key to the firmware lock, whereby the digital content is accessed.

11. The method of claim 10, wherein the digital key is integrated into the digital player.

12. The method of claim 10, wherein the digital key is not integrated into the digital player and in step (e), the digital key is transmitted to the firmware lock via a local area network, a wide-area network, or a global computer network.

13. The method of claim 10, wherein in step (a) the digital content storage device is a remote server accessible by a global computer network; in step (c), the digital content player is a remote computer operationally connected to the remote server via the global computer network, and wherein the digital key is transmitted from the remote computer to the remote server via the global computer network.

14. A system for renting or selling digital content, the system comprising, in combination:
a digital content storage device having stored therein digital content to be rented;
a firmware lock embedded within the digital content storage device that disables access to the digital content in the absence of a corresponding digital key;
a digital content player dimensioned and configured to access and to play the digital content stored in the digital content storage device, wherein the digital content player is configured such that it is incapable of accessing or playing the digital content in the absence of the corresponding digital key; and
the corresponding digital key, wherein the digital content player is configured to access and to play the digital content when, and only when, the corresponding digital key is transmitted to the firmware lock.

15. The system of claim 14, wherein the digital content storage device is selected from the group consisting of a server, a magnetic disc, a magnetic tape, an audio compact disc, a video compact disc, a memory chip, and a personal media player.

16. The system of claim 14, wherein the firmware lock and key comprise Advanced Encryption Standard (AES)-compliant code.

17. The system of claim 14, wherein the firmware lock and key comprise a Rijndael cipher of 128 bits, 196 bits, or 256 bits.

18. The system of claim 14, wherein the digital content player is selected from the group consisting of a computer, a digital audio tape player, a compact disc player, a video compact disc player, and a personal media player.

19. The system of claim 14, wherein the digital key is integrated into the digital player.

20. A system for renting or selling digital content, the system comprising, in combination:
a digital content storage device having stored therein digital content to be rented;
a firmware lock embedded within the digital content storage device that disables access to the digital content in the absence of a corresponding digital key;
a digital content player dimensioned and configured to access and to play the digital content stored in the digital content storage device, wherein the digital content player is configured such that it is incapable of accessing or playing the digital content in the absence of the corresponding digital key; and
the corresponding digital key, wherein the digital content player is configured to access and to play the digital content when, and only when, the corresponding digital key is transmitted to the firmware lock, wherein the firmware lock and key comprise a Rijndael cipher of 128 bits, 196 bits, or 256 bits.
